(19) United States
(12) Patent Application Publication
(10) Pub. No.: US 2025/0293316 A1
(43) Pub. Date: Sep. 18, 2025

(54) NONAQUEOUS ELECTROLYTE BATTERY AND BATTERY PACK

(71) Applicant: KABUSHIKI KAISHA TOSHIBA, Tokyo (JP)

(72) Inventors: Hidetoshi WATANABE, Yokohama Kanagawa (JP); Yuki WATANABE, Yokohama Kanagawa (JP); Ryo HARA, Kawasaki Kanagawa (JP)

(73) Assignee: KABUSHIKI KAISHA TOSHIBA, Tokyo (JP)

(21) Appl. No.: 19/223,210

(22) Filed: May 30, 2025

Related U.S. Application Data
(63) Continuation of application No. PCT/JP2023/011632, filed on Mar. 23, 2023.

(51) Int. Cl. H01M 10/0587; H01M 4/485; H01M 10/0525; H01M 50/417; H01M 50/46; H01M 50/491

(52) U.S. Cl. CPC H01M 10/0587; H01M 4/485; H01M 10/0525; H01M 50/417; H01M 50/46; H01M 50/491

(57) ABSTRACT

In general, according to one embodiment, a nonaqueous electrolyte battery includes an electrode group and a nonaqueous electrolyte. The electrode group includes a flatly wound stack including a positive electrode, a negative electrode, and a separator. Z/Y, where an air permeability of the separator located in a curved portion of the electrode group is Y (sec/100 mL) and an air permeability of the separator located in a flat portion of the electrode group is Z (sec/100 mL), is 1.03≤Z/Y≤1.11.

### CROSS-REFERENCE TO RELATED APPLICATION(S)

This application is a Continuation application of PCT application No. PCT/JP2023/011632, filed Mar. 23, 2023, the entire contents of which are incorporated herein by reference.

### FIELD

Embodiments described herein relate generally to a nonaqueous electrolyte battery and a battery pack.

### BACKGROUND

A nonaqueous electrolyte battery includes a positive electrode, a negative electrode, and a separator. Thinning the separator can increase the occupancy of the electrodes, that is, increase the area where the positive electrode and the negative electrode face each other, and accordingly, a cell can be endowed with an enhanced outputting ability. Meanwhile, thinning the separator could incur poor self-discharging performance or a short-circuiting-associated high defective ratio, or may lead to problems such as a resistance increase due to hampered penetration of an electrolyte solution into the electrode group.

### BRIEF DESCRIPTION OF THE DRAWINGS

FIG. 1 is an exploded perspective view of an exemplary nonaqueous electrolyte battery according to an embodiment.

FIG. 2 is a partially unfolded perspective view of an electrode group for use in the nonaqueous electrolyte battery shown in FIG. 1.

FIG. 3 is a perspective view schematically showing an appearance of the nonaqueous electrolyte battery shown in FIG. 1.

FIG. 4 is a sectional view showing an observed cross section of the nonaqueous electrolyte battery shown in FIG. 3.

FIG. 5 is an enlarged sectional view of the observed cross section shown in FIG. 4.

FIG. 6 is an enlarged sectional view of a portion A of the electrode group shown in FIG. 5.

FIG. 7 is a plan view of a separator 8 shown in FIG. 6.

FIG. 8 is a plan view of the electrode group shown in FIG. 5.

FIG. 9 is a partially cutaway perspective view showing another exemplary nonaqueous electrolyte battery according to the embodiment.

FIG. 10 is an enlarged sectional view of a portion B of the battery shown in FIG. 9.

FIG. 11 is an exploded perspective view showing an exemplary battery pack according to the embodiment.

FIG. 12 is a block diagram showing an exemplary electric circuit for the battery pack shown in FIG. 11.

### DETAILED DESCRIPTION

In general, according to one embodiment, a nonaqueous electrolyte battery includes an electrode group and a nonaqueous electrolyte. The electrode group includes a flatly wound stack including a positive electrode, a negative electrode, and a separator arranged between the positive electrode and the negative electrode. Z/Y, where an air permeability of the separator located in a curved portion of the electrode group is Y (sec/100 mL) and an air permeability of the separator located in a flat portion of the electrode group is Z (sec/100 mL), is 1.03≤Z/Y≤1.11.

According to another embodiment, a battery pack includes the nonaqueous electrolyte battery according to the embodiment.

### First Embodiment

An embodiment will be described with reference to the drawings. Note that the description will use, in relation to all the drawings, the same reference signs for elements or components that provide the same or similar functions so that repetitive explanations will be avoided. Each drawing is schematic and intended to facilitate the explanation and understanding of each embodiment. Shapes, sizes, ratios, etc., read from the drawings may differ from those of actual devices or the like, but they may undergo suitable design changes in light of the disclosure herein and the known art.

For “air permeability” of a separator, the following techniques have been proposed. It has been proposed to set the air permeability of a separator in a curved portion of an electrode group to be higher than that of a separator in a flat portion continuous with the curved portion. This proposal is said to contribute to the mitigation of battery reactions at the curved portion, the reducing of stresses occurring inside the electrode group due to expansion and contraction accompanying the charge and discharge reactions, and the prevention of cracks in a positive electrode current collector, etc., arranged in the curved portion. With the flat portion having a low air permeability, however, poor self-discharging performance and short circuiting would result.

It has also been proposed to set air permeability of a separator located in a flat portion of an electrode group to be equal to or larger than air permeability of a separator located in the pair of curved portions of the electrode group (for example, a ratio of air permeability of the separator located in the pair of curved portions to that of the separator located in the flat portion being 0.5 or more and 0.9 or less). The intention of this proposal is to cause an electrolyte solution that is stocked in the curved portions at the contraction of the flat portion to return to the flat portion so that the shortage of the electrolyte solution in the flat portion and the resulting deterioration of the cycle characteristics are prevented. However, with the air permeability of the flat portion being larger than that of the curved portions, the injected electrolyte solution would not penetrate into the flat portion of the electrode group while penetrating into the curved portions having a lower air permeability, resulting in a resistance increase and deteriorated cycle characteristics.

It has further been proposed to set the percentage of the air permeability of the outermost flat portion of a wound electrode group with respect to the air permeability of the outermost curved portion of the wound electrode group to be larger (for example, between 161% and 278%). Here, the air permeability of separator inside the wound electrode group is not specified. The intention of this proposal is to have the electrode reactions at the flat portion and the curved portion in good balance and to improve the resistance to Li deposition, so that the degradation of an electrode in the flat portion is suppressed. However, with the air permeability of the flat portion being larger than that of the curved portion, the injected electrolyte solution would not penetrate into the flat portion of the electrode group while penetrating into the curved portion having a lower air permeability, resulting in a resistance increase and deteriorated cycle characteristics.

The present inventors have repeated extensive studies and reached the following findings. They have found that, for a nonaqueous electrolyte battery including an electrode group and a nonaqueous electrolyte, in which the electrode group is constituted by a flatly wound stack including a positive electrode, a negative electrode, and a separator arranged between the positive electrode and the negative electrode, it is possible to improve self-discharging performance, prevent short circuiting, and also reduce resistance by setting an air permeability Y (sec/100 mL) of the separator located in the curved portion of the electrode group and an air permeability Z (sec/100 mL) of the separator located in the flat portion of the electrode group to satisfy 1.03≤z/Y≤1.11.

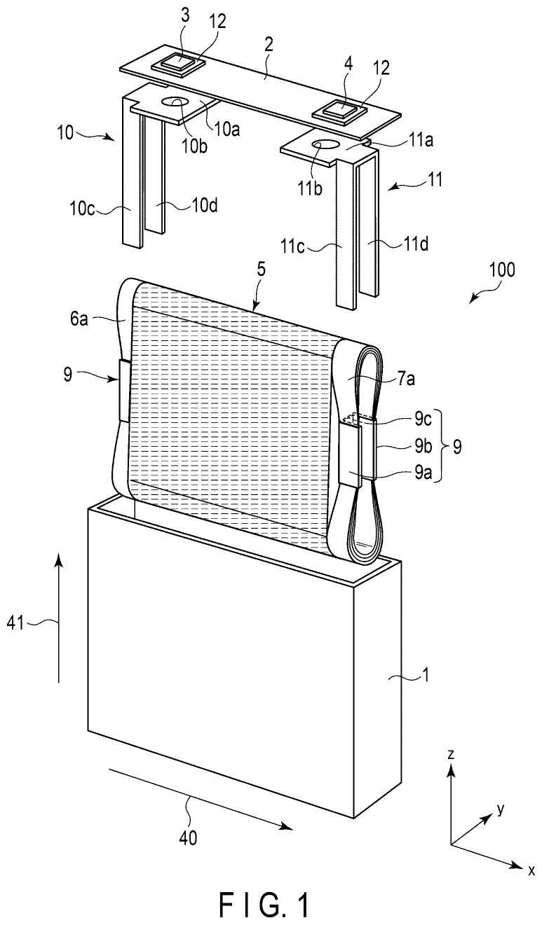

A battery according to an embodiment will be described in detail with reference to FIGS. 1 to 7.

FIG. 1 is an exploded perspective view of an exemplary nonaqueous electrolyte battery according to an embodiment. The battery shown in FIG. 1 is a sealed rectangular nonaqueous electrolyte battery. The nonaqueous electrolyte battery shown in FIG. 1 includes a container can 1, a lid 2, a positive electrode external terminal 3, a negative electrode external terminal 4, and an electrode group 5. The container can 1 and the lid 2 constitute a container member. The container can 1 has a bottomed rectangular tube shape and is made of a metal such as aluminum, an aluminum alloy, iron, or stainless steel. The bottom surface of the container can 1 is defined by long sides which are parallel to a winding axis direction 40 of the electrode group 5 and short sides which cross the long sides perpendicularly or substantially perpendicularly. A height direction 41 of the container can 1 is a direction which crosses the bottom surface of the container can 1 perpendicularly or substantially perpendicularly. In FIG. 1, the x-axis direction is parallel to the winding axis direction 40. The y-axis direction is perpendicular to the winding axis direction 40 and parallel to the short sides of the container can 1. The z-axis direction is parallel to the height direction 41 of the container can 1.

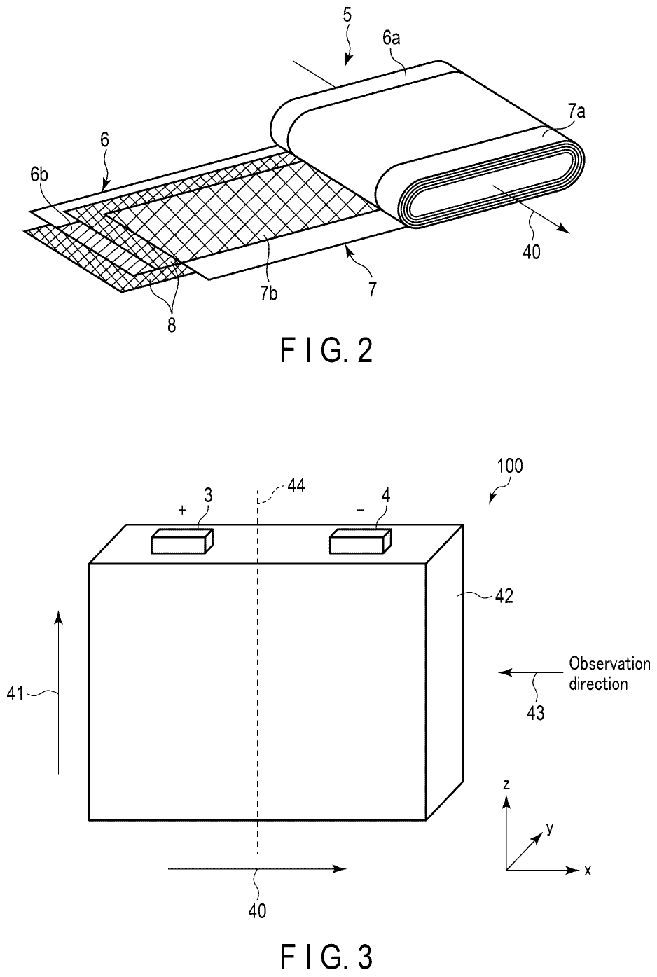

FIG. 2 is a partially unfolded perspective view of the electrode group for use in the nonaqueous electrolyte battery shown in FIG. 1. As shown in FIG. 2, the flat electrode group 5 is formed by winding a positive electrode 6 and a negative electrode 7 into a flat shape with a respective separator 8 interposed therebetween. The positive electrode 6 includes, in one example, a strip-shaped positive electrode current collector made of a metal foil, a positive electrode current collecting tab 6a formed of one end portion of the positive electrode current collector that is parallel to the long side, and a positive electrode material layer (positive electrode active material-containing layer) 6b formed over the positive electrode current collector excluding at least a portion where the positive electrode current collecting tab 6a is present. On the other hand, the negative electrode 7 includes, in one example, a strip-shaped negative electrode current collector made of a metal foil, a negative electrode current collecting tab 7a formed of one end portion of the negative electrode current collector that is parallel to the long side, and a negative electrode material layer (negative electrode active material-containing layer) 7b formed over the negative electrode current collector excluding at least a portion where the negative electrode current collecting tab 7a is present.

The positive electrode 6, the separator 8, and the negative electrode 7 as above are wound together such that the positive electrode 6 and the negative electrode 7 are displaced from each other so as to have the positive electrode current collecting tab 6a protruding from the separator 8 in the winding axis direction 40 of the electrode group and the negative electrode current collecting tab 7a protruding from the separator 8 in the direction opposite to the winding axis direction 40. By this winding, therefore, the electrode group 5 is provided with the positive electrode current collecting tab 6a which is spirally wound and sticks out from one end face, and the negative electrode current collecting tab 7a which is spirally wound and sticks out from the other end face, as shown in FIG. 2. The electrode group 5 is impregnated with a nonaqueous electrolyte (not shown in the figure).

As shown in FIG. 1, the positive electrode current collecting tab 6a and the negative electrode current collecting tab 7a are each divided into two bundles with a boundary set in the vicinity of the winding center of the electrode group. A conductive holding member 9 has substantially U-shaped first and second holding parts 9a and 9b, and a connecting part 9c for electrically connecting the first and second holding parts 9a and 9b. In each of the positive and negative electrode current collecting tabs 6a and 7a, one of the bundles is held by the first holding part 9a and the other bundle is held by the second holding part 9b.

The positive electrode lead 10 includes a substantially rectangular support plate 10a, a through-hole 10b opened in the support plate 10a, and strip-shaped current collecting parts 10c and 10d branching from the support plate 10a and extending downward. On the other hand, the negative electrode lead 11 includes a substantially rectangular support plate 11a, a through-hole 11b opened in the support plate 11a, and strip-shaped current collecting parts 11c and 11d branching from the support plate 11a and extending downward.

The positive electrode lead 10 sandwiches the corresponding holding member 9 between the current collecting parts 10c and 10d. The current collecting part 10c is arranged for the first holding part 9a of this holding member 9. The current collecting part 10d is arranged for the second holding part 9b. The current collecting parts 10c and 10d, the first and second holding parts 9a and 9b, and the positive electrode current collecting tab 6a are joined together by, for example, ultrasonic welding. Thus, the positive electrode 6 of the electrode group 5 and the positive electrode lead 10 are electrically connected to each other via the positive electrode current collecting tab 6a.

The negative electrode lead 11 sandwiches the corresponding holding member 9 between the current collecting parts 11c and 11d. The current collecting part 11c is arranged for the first holding part 9a of this holding member 9. On the other hand, the current collecting part 11d is arranged for the second holding part 9b. The current collecting parts 11c and 11d, the first and second holding parts 9a and 9b, and the negative electrode current collecting tab 7a are joined together by, for example, ultrasonic welding. Thus, the negative electrode 7 of the electrode group 5 and the negative electrode lead 11 are electrically connected to each other via the negative electrode current collecting tab 7a.

Materials of the positive and negative electrode leads 10 and 11 and the holding members 9 are not particularly specified, but the same materials as those of the positive and negative electrode external terminals 3 and 4 are preferably employed. In one example, aluminum or an aluminum alloy is used for the positive electrode external terminal 3, and aluminum, an aluminum alloy, copper, nickel, nickel-plated iron, or the like is used for the negative electrode external terminal 4. If the material of the external terminal is aluminum or an aluminum alloy, the material of the corresponding lead is preferably aluminum or an aluminum alloy. If the external terminal is made of copper, the material of the corresponding lead is preferably copper or the like.

The lid 2 having a rectangular plate shape is, in one example, seam welded to the opened part of the container can 1 by a laser. The lid 2 is formed of, for example, a metal such as aluminum, an aluminum alloy, iron, or stainless steel. The lid 2 and the container can 1 are preferably formed of the same kind of metal. The positive electrode external terminal 3 is electrically connected to the support plate 10a of the positive electrode lead 10, and the negative electrode external terminal 4 is electrically connected to the support plate 11a of the negative electrode lead 11. An insulating gasket 12 is disposed between the lid 2 and each of the positive and negative electrode external terminals 3 and 4 to electrically insulate the positive and negative electrode external terminals 3 and 4 from the lid 2. Each insulating gasket 12 is preferably a resin molded product.

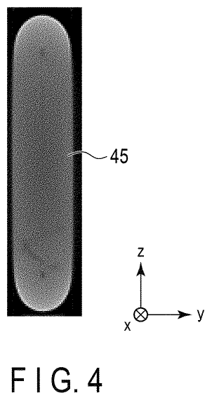

A description will be given of a method for measuring the air permeability of the separator in a flat wound electrode group, referring to the nonaqueous electrolyte battery shown in FIGS. 1 and 2 as an example. FIG. 3 is a perspective view schematically showing an appearance of the nonaqueous electrolyte battery shown in FIG. 1. Note that FIG. 3 omits the insulating gaskets 12. FIG. 4 shows an observed cross section of the nonaqueous electrolyte battery. As shown in FIG. 3, a cross section of the electrode group is observed by X-ray computed tomography (X-ray CT) in, as the observation direction, a direction 43 which is parallel to the winding axis direction 40 of the electrode group and which crosses a short side surface 42 located on the negative electrode side. For the X-ray CT, for example, the TX Scanner manufactured by Toshiba IT & Control Systems Corporation or equipment having comparable functions is used. Here, the short side surface 42 on the negative electrode side refers to, among the side surfaces defined by the sides parallel to the height direction 41 and the short sides of the container can 1, a side surface located near the negative electrode current collecting tab 7a of the electrode group 5 or near the negative electrode external terminal 4.

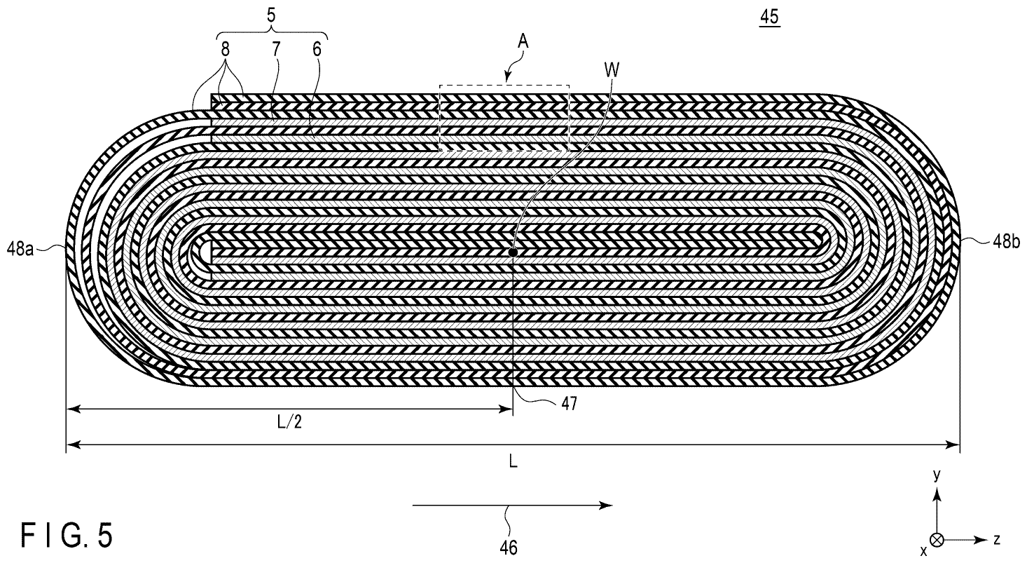

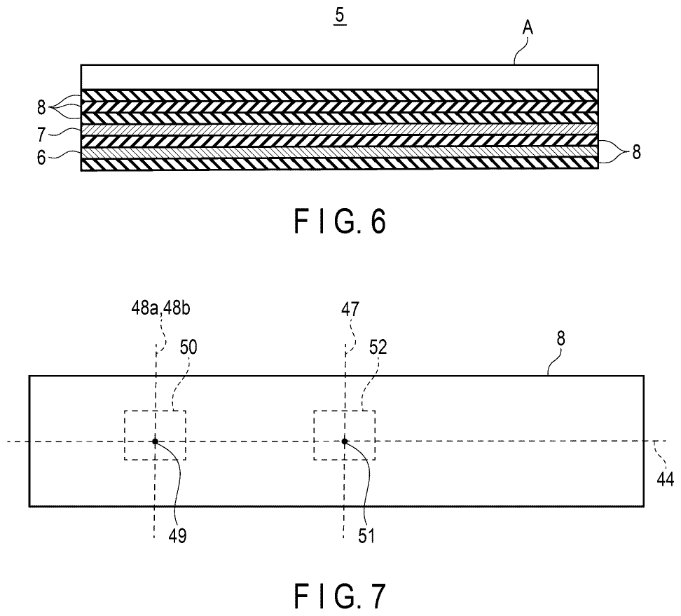

As the observed cross section of the electrode group 5, a cross section 45 located at the middle 44 of the long side which is along the x-axis direction of the container can 1 is observed. A schematic view of the cross section 45 is shown in FIG. 4, while a detailed view of the cross section 45 is shown in FIG. 5. Also, a portion A indicated in FIG. 5 is shown in FIG. 6. Curved portions (R portions) of the flat wound electrode group 5 are located at respective ends of the electrode group 5 in the direction perpendicular to the winding axis direction 40. Note that the direction perpendicular to the winding axis direction 40 is parallel to the z-axis direction or the height direction 41. In each of the curved portions (R portions), the positive electrode 6, the negative electrode 7, and the separator 8 are curved in a circular arc shape or in an arc shape. The positive electrode 6, the negative electrode 7, and the separator 8 in one curved portion are curved so as to be convex toward one end side in the direction perpendicular to the winding axis direction 40. The positive electrode 6, the negative electrode 7, and the separator 8 in the other curved portion are curved so as to be convex toward the other end portion side in the direction perpendicular to the winding axis direction 40. It may be said that the curved portions (R portions) of the flat wound electrode group 5 are curved portions including the respective long axis end portions of an ellipse when a cross section that is along the direction perpendicular to the winding axis direction 40 (e.g., the cross section 45) is observed. On the other hand, the flat portions of the flat wound electrode group 5 are portions sandwiched by the two curved portions (R portions). In each flat portion, the positive electrode 6, the negative electrode 7, and the separator 8 are arranged substantially parallel to the direction perpendicular to the winding axis direction 40 (or parallel to the z-axis direction or the height direction 41). The flat portions of the flat wound electrode group 5 may be said to be linear portions other than the curved portions (R portions) of the electrode group 5. As shown in FIGS. 5 and 6, the separator 8 are located in the outermost circumference of the electrode group 5 and in the first and the second rounds inside the outermost circumference. In the electrode group 5, the negative electrode 7 is located outside the positive electrode 6. As such, the negative electrode 7 is located near the outermost separator 8. Note that the arrangement of the positive electrode and the negative electrode is not limited to what is shown in FIGS. 5 and 6, and it is also possible to locate the positive electrode outside the negative electrode. Also, the positive electrode or the negative electrode, instead of the separator, may be located in the outermost circumference.

For the cross section 45 of the electrode group 5, a length L of the electrode group 5 in a longitudinal direction 46 along the z-axis direction, and the middle 47 of this length L are determined. The length L in the longitudinal direction 46 represents a distance between one curved portion 48a and the other curved portion 48b of the electrode group 5 through a winding center W of the electrode group 5. The middle 47 is located at or near the center of the flat portion of the electrode group 5.

In the electrode group 5, a desired round of the separator 8 that is arranged between the positive electrode 6 and the negative electrode 7 is selected. More specifically, the battery 100 is discharged to 1.5 V and subsequently the electrode group 5 is taken out from the container can 1. One round of the separator 8 facing the positive electrode 6 and the negative electrode 7 is cut out. In the cutout separator 8, a first region 50 having a square shape is set as shown in FIG. 7. The first region 50 has its center on a first intersection 49 where a line passing through a position corresponding to one curved portion 48a or the other curved portion 48b defining the length L intersects with a line passing through a position corresponding to the middle 44 of the long side of the container can 1. For this setting, either of the curved portion 48a and the curved portion 48b may be used. The square shape of the first region 50 is set so that its sides each have a length of 5 cm. Also, in the cutout separator 8, a second region 52 having a square shape is set as shown in FIG. 7. The second region 52 has its center on a second intersection 51 where a line passing through a position corresponding to the middle 47 of the length L intersects with a line passing through a position corresponding to the middle 44 of the long side of the container can 1. As the length of the cutout separator 8 is of one round, there are two positions corresponding to the middle 47 of the length L in the cutout separator 8. Either one of the two positions may be used for the second region 52. The square shape of the second region 52 is set so that its sides each have a length of 5 cm. The first region 50 is employed as a measurement region for air permeability Y of the separator 8 in the curved portion (R portion) of the electrode group 5. Also, the second region 52 is employed as a measurement region for air permeability Z of the separator 8 in the flat portion of the electrode group 5. The air permeability is measured according to the method specified in JIS8117 (2009). As a concrete method, air permeability is obtained by measuring the time required for 100 mL to pass through the measurement region of the separator, using a Gurley type densometer manufactured by Toyo Seiki Seisaku-sho, Ltd.

The present inventors have found that there is a correlation between a ratio X of the air permeability Z to the air permeability Y measured by this method (Z/Y) and properties of the battery including self-discharging performance, anti-short-circuiting properties, and resistance. With the ratio X (Z/Y) being less than 1.03, the self-discharging performance of the battery is poor. The anti-short-circuiting properties are also deteriorated, which incurs an easy occurrence of short circuiting. Note that the separator located in the curved portion (R portion) of the electrode group are impregnated with an electrolyte solution from a direction parallel to the winding axis. On the other hand, the flat portion of the electrode group is located in a direction substantially perpendicular to the winding axis. As such, with the ratio X (Z/Y) being more than 1.11, the penetration of an electrolyte solution into the flat portion is delayed. This results in insufficient penetration of the electrolyte solution into the inside of the electrodes located in the flat portion, and consequently, the battery resistance will increase. It has been found that the self-discharging performance, the anti-short-circuiting properties, and the low resistance are all achieved by setting the ratio X (Z/Y) in the range of 1.03 or more and 1.11 of less. In other words, by setting the ratio X (Z/Y) to be in the range from 1.03 to 1.11, it is possible to suppress the self-discharge, short circuiting, and resistance increase of the battery. The upper limit of the ratio X (Z/Y) may be set to 1.110.

Each of the air permeabilities Y and Z of the separator is preferably 10 sec/100 mL or more and 100 sec/100 mL or less. By setting the air permeabilities Y and Z of the separator in this range, it is possible to suppress the resistance increase by effectively allowing gas generated at the electrode surfaces to be released to the outside of the separator without remaining within the electrode group, while suppressing the short circuiting between the positive and negative electrodes. A more preferred range of each of the air permeabilities Y and Z of the separator is 20 sec/100 mL or more and 100 sec/100 mL or less.

The nonaqueous electrolyte battery according to the embodiment will be described in more detail. First, each of the electrode group, the positive electrode, the negative electrode, the separator, and the nonaqueous electrolyte will be described.

### (Electrode Group)

The electrode group has a structure in which a stack including a strip-shaped positive electrode, a strip-shaped negative electrode, and a separator is wound into a flat shape. Preferably, the electrode group is inserted in a container member along a direction perpendicular to the winding axis direction. The electrode group may include a space inside its innermost circumference and surrounded by the side of the innermost circumference. This space may be formed by the removal of a winding axis from the electrode group. At least a part of each separator is disposed between the positive electrode and the negative electrode. The separator may have a portion that is in contact with only the positive electrode or the negative electrode. The positive electrode, the negative electrode, or the separator is located at the outermost circumference of the electrode group. The layer located at the outermost circumference of the electrode group is preferably fixed by an insulating tape.

The positive electrode and the negative electrode extend in a first direction (long side direction) with the separator interposed therebetween, and each have a strip shape having a width in a second direction (winding axis direction) orthogonal to the first direction. A region on the positive electrode current collector where the positive electrode material layer is provided will be called a “positive electrode coated portion”, and a region of the positive electrode current collector where the positive electrode material layer is not provided will be called a “positive electrode uncoated portion”. The positive electrode uncoated portion serves as the positive electrode current collecting tab. A region on the negative electrode current collector where the negative electrode material layer is provided will be called a “negative electrode coated portion”, and a region of the negative electrode current collector where the negative electrode material layer is not provided will be called a “negative electrode uncoated portion”. The negative electrode uncoated portion serves as the negative electrode current collecting tab. The positive electrode, the positive electrode current collector, the positive electrode material layer, the negative electrode, the negative electrode current collector, and the negative electrode material layer may each have a strip shape. It is preferable to conduct winding together with position adjustment so that the surface of the positive electrode material layer will face the surface of the negative electrode material layer, that is, the positive electrode will not include a non-facing portion.

The electrode group is obtained by, for example, winding a positive electrode and a negative electrode with a separator interposed therebetween into a flat shape or a cylindrical shape, and then subjecting the resultant to a pressing process. The pressing temperature may be set to, for example, a room temperature of 25° C. or so. A more preferred range of the press temperature is 20° C. or higher and 30° C. or lower.

The ratio X (Z/Y) is adjustable, and it may be adjusted by, for example, changing the pressing pressure, the pressing temperature, etc., used during the manufacture of the electrode group, the kind of materials which constitute the separator, and so on.

The electrode group preferably has an aspect ratio in the range of 1.1 or more and 1.7 or less. Setting the aspect ratio of the electrode group to be in the range from 1.1 to 1.7 provides an appropriate distance from the end face of the electrode group to the center of the electrode group in the direction parallel to the winding axis, which realizes easy penetration of the electrolyte solution and a reduced resistance. A more preferred range is 1.15 or more and 1.5 or less.

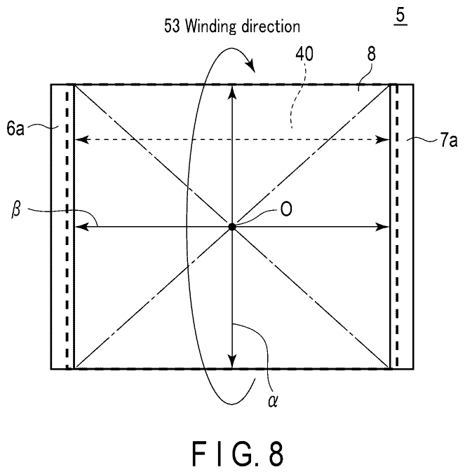

With reference to FIG. 8, the aspect ratio is defined as follows. There is the electrode group 5 constituted by the positive electrode 6, the separator 8, and the negative electrode 7 wound in a winding direction 53 into a flat shape. In one example, the outermost circumference of the electrode group 5 is formed of the separator 8. The positive electrode current collector (positive electrode current collecting tab 6a) protrudes from the separator 8 on one side in the winding axis direction 40, and the negative electrode current collector (negative electrode current collecting tab 7a) protrudes from the separator 8 on the other side. On the largest-area surface of the electrode group 5, a point of intersection between two diagonals of the outermost separator 8 is denoted by O. Assuming that the length in the direction passing through the intersection point O and perpendicular to the winding axis direction 40 is α and the length in the direction passing through the intersection point O and parallel to the winding axis direction 40 is β, the aspect ratio is represented by β/α. Since the electrolyte solution penetrates in the direction parallel to the winding axis, setting the aspect ratio (β/α) to 1.1 or more and 1.7 or less facilitates the penetration of the electrolyte solution to the center of the electrode group along the curved portions (R portions), and then the electrolyte solution easily penetrates to the flat portions.

The aspect ratio is measured by the following method. The container member of the battery is disassembled without damaging the inside electrode group so that the electrode group is taken out. The above described lengths a and B are measured using a digital caliper. The lengths a and B across the center of a part of the electrode group that is covered by the separator (excluding a part exposed from the separator). The value β/α is the aspect ratio of the electrode group.

The ratio of the separator which make up the electrode group is preferably in the range of 0.07 or more and 0.15 or less. With this range, the separator located in each of the curved portions (R portions) and the flat portions have appropriate porosities, and accordingly, the penetration of the electrolyte solution into the electrode group from the separator located in the R portions is facilitated so that the effect of reducing the resistance can be easily attained. A more preferred range is 0.09 or more and 0.13 or less.

### (Positive Electrode)

The positive electrode includes a current collector and a positive electrode material layer (positive electrode active material-containing layer) formed on at least one surface of the current collector. The positive electrode material layer contains an active material, and may optionally contain a binder and a conductive agent.

The positive electrode active material includes a lithium-containing metal oxide. Examples of the lithium-containing metal oxide include lithium nickel composite oxides, lithium nickel cobalt manganese composite oxides (e.g., LiₐNi_{(1-x-y)}CoₓMn_{y}O₂, where 0.9<a≤1.2, 0<x≤0.5, 0<y≤0.5, and 0.6≤1−x−y≤0.9), lithium nickel manganese composite oxides (e.g., LiₓCo_{1-y-z}Mn_{y}Ni_{z}O₂, where 0<x≤1, 0<y≤1, 0<z≤1, and 0≤1−y−z≤1), lithium manganese composite oxides (e.g., lithium manganese composite oxides having a spinel structure (LiₓMn₂O₄, where 0<x≤1), and LiₓMnO₂, where 0<x≤1), lithium cobalt composite oxides (e.g., lithium cobalt composite oxides having a layered rock salt structure (LiₓCoO₂, where 0<x≤1)), lithium manganese cobalt composite oxides (LiₓMn_{2-y}Co_{y}O₄, where 0<x≤1 and 0<y<2), lithium iron composite oxides (e.g., LiₓFePO₄ and LiₓFe_{1-y}Mn_{y}PO₄, where 0<x≤1 and 0<y<1), and so on. One or a combination of two or more kinds of such lithium-containing metal oxides may be employed.

As the positive electrode active material, it is preferable to employ any one or more of the lithium nickel cobalt manganese composite oxides, the lithium manganese composite oxides, and the lithium cobalt composite oxides.

The positive electrode active material may be in the form of primary particles or secondary particles constituted by aggregation of primary particles.

Any binder generally used in nonaqueous electrolyte batteries may be employed. For example, electrochemically stable polyvinylidene fluoride (PVdF), polytetrafluoroethylene, or the like may be employed. The binder here may be constituted by one or a combination of two or more kinds of binders.

As the conductive agent, any material may be employed as long as it gives a suitable conductivity. For example, carbon black such as acetylene black, carbon material such as graphite, etc., may be used. The conductive agent here may be constituted by one or a combination of two or more kinds of conductive agents. Examples of the conductive agent in the form of secondary particles include acetylene black.

The positive electrode current collector may be a conductive thin film provided with the positive electrode material layer on one or both of its surfaces. As the positive electrode current collector, it is possible to employ a non-porous metal foil, punched metal having a large number of pores, metal mesh formed of molded metal thin wires, and so on. The positive electrode current collector to be employed may be, for example, a metal foil or an alloy foil. Examples of the metal foil include an aluminum foil, a copper foil, and a nickel foil. Examples of the alloy include an aluminum alloy, a copper alloy, and a nickel alloy.

A material of the positive electrode current collector is not particularly limited, and any material may be employed as long as it does not dissolve under battery usage environments. Examples of the positive electrode current collector include metals such as Al or Ti, and alloys containing such a metal as a main component and one or more additive elements selected from the group consisting of Zn, Mn, Fe, Cu, and Si. In particular, an aluminum alloy foil containing Al as a main component is preferably employed as a thin film which is flexible and excels in formability. Typically, it is preferred for the positive electrode current collector to have a thickness of 5 μm or more and 20 μm or less.

The weight ratios of the positive electrode active material, the conductive agent, and the binder for mixture are preferably set to 80% or more and 96% or less for the positive electrode active material, 3% or more and 15% or less for the conductive agent, and 0.5% or more and 58 or less for the binder. The amount of the conductive agent being 3% or more can realize an enhanced current collecting performance of the positive electrode material layer. Also, the amount of the binder being 0.5% or more can realize enhanced binding between the positive electrode material layer and the current collector, which allows for the expectation of excellent cycle characteristics. Note that, for achieving an increased capacity, the sum of the conductive agent and the binder is preferably set to 20 wt % or less.

A portion of the positive electrode current collector where the positive electrode material layer is not formed may serve as a positive electrode current collecting tab.

The positive electrode in one example is obtained by the following method. For example, the positive electrode active material, the conductive agent, and the binder are suspended in a suitable solvent, the thus-prepared slurry is applied to the positive electrode current collector, and the resultant is dried and rolled to provide the positive electrode.

### (Negative Electrode)

The negative electrode includes a negative electrode current collector, and a negative electrode material layer containing a negative electrode active material. A preferred form of the negative electrode is that the negative electrode material layer is present on one or both surfaces of the negative electrode current collector, and a more preferred form is that the negative electrode material layer is present on both surfaces of the negative electrode current collector. The negative electrode material layer may contain a conductive agent or a binder. The negative electrode material layer is a layer containing at least a negative electrode active material dispersed therein, and is provided on the negative electrode current collector.

Examples of the negative electrode active material include metal composite oxides, carbonaceous materials, and metal compounds. The negative electrode active material here may be constituted by one or a combination of two or more kinds of negative electrode active materials.

Examples of the metal composite oxides include titanium-containing oxides. Examples of the titanium-containing oxides include a spinel-type lithium titanate represented by Li₄₊ₓTi₅O₁₂, where x varies in the range of −1≤x≤3 depending on charge and discharge reactions, a ramsdellite-type lithium titanate represented by Li₂₊ₓTi₃O₇, where x varies in the range of −1≤x≤3 depending on charge and discharge reactions, and a metal composite oxide containing Ti and at least one element selected from the group consisting of P, V, Sn, Cu, Ni, and Fe. Examples of the metal composite oxide containing Ti and at least one element selected from the group consisting of P, V, Sn, Cu, Ni, and Fe include TiO₂—P₂O₅, TiO₂—V₂O₅, TiO₂—P₂O₅—SnO₂, and TiO₂—P₂O₅-MO, where M is at least one element selected from the group consisting of Cu, Ni, and Fe. Other examples include niobium titanium composite oxides such as TiNb₂O₇ and Ti₂Nb₁₀O₁₉. These titanium-containing oxides are changed to lithium titanium composite oxides by undergoing lithium insertions in charging.

Examples of the carbonaceous materials may include natural graphite, artificial graphite, coke, vapor-grown carbon fiber, mesophase pitch-based carbon fiber, spherical carbon, and resin-fired carbon. Preferred carbonaceous materials may be vapor-grown carbon fiber, mesophase pitch-based carbon fiber, and spherical carbon. It is preferable for the carbonaceous materials to have a (002) plane with a lattice spacing d₀₀₂ of 0.34 nm or less according to X-ray diffraction.

As the metal compounds, a metal sulfide and a metal nitride may be employed. As the metal sulfide, for example, a titanium sulfide such as TiS₂, a molybdenum sulfide such as MoS₂, and an iron sulfide such as FeS, FeS₂, or LixFeS₂ may be used. As the metal nitride, for example, a lithium cobalt nitride (e.g., LiₛCOₜN, where 0<s<4 and 0<t<0.5) may be used.

As the conductive agent, any material may be employed as long as it gives a suitable conductivity. For example, carbon black such as acetylene black, carbon material such as graphite, etc., may be used. The conductive agent here may be constituted by one or a combination of two or more kinds of conductive agents.

Any binder generally used in nonaqueous electrolyte batteries may be employed. Preferably, electrochemically stable materials such as polyvinylidene fluoride (PVdF), polytetrafluoroethylene, carboxymethylcellulose, styrene butadiene rubber, and mixtures thereof are used. The binder here may be constituted by one or a combination of two or more kinds of binders.

The negative electrode current collector is a conductive thin film provided with the negative electrode material layer on one or both of its surfaces. For the negative electrode current collector, similar materials to those of the positive electrode current collector may be employed.

For example, the negative electrode is produced in such a manner that the negative electrode active material, the conductive agent, and the binder are suspended in a suitable solvent, the thus-prepared slurry is applied to the negative electrode current collector, and the resultant is dried and rolled. In the negative electrode, a portion of the negative electrode current collector where the negative electrode material layer is not formed on its surface serves as a negative electrode current collecting tab.

The weight ratios of the negative electrode active material, the conductive agent, and the binder are preferably set to 80% or more and 96% or less for the negative electrode active material, 2% or more and 18% or less for the conductive agent, and 1% or more and 58 or less for the binder. The amount of the conductive agent being 2% or more can realize an enhanced current collecting performance of the negative electrode material layer. Also, the amount of the binder being 18 or more can realize enhanced binding between the negative electrode material layer and the negative electrode current collector, which allows for the expectation of excellent cycle characteristics. Note that, for achieving an increased capacity, the sum of the conductive agent and the binder is preferably set to 20% or less.

### (Nonaqueous Electrolyte)

For example, a nonaqueous electrolyte solution, a gel electrolyte, a solid electrolyte, etc. may be used as the nonaqueous electrolyte. The nonaqueous electrolyte solution refers to a solution containing an electrolyte salt and a nonaqueous solvent. Examples of the electrolyte salt include lithium salts such as LiPF₆, LiBF₄, Li(CF₃SO₂)₂N (lithium bistrifluoromethanesulfonylamide; commonly known as LiTFSI), LiCF₃SO₃ (commonly known as LiTFS), Li(C₂F₅SO₂)₂N (lithium bispentafluoroethanesulfonylamide; commonly known as LiBETI), LiClO₄, LiAsF₆, LiSbF₆, lithium bisoxalatoborate {LiB(C₂O₄)₂, commonly known as LiBOB}, and lithium difluoro(trifluoro-2-oxide-2-trifluoro-methylpropionato(2-)-0,0)borate {LiBF₂OCOOC(CF₃)₂, commonly known as LiBF₂(HHIB)}. One or a combination of two or more kinds of such electrolyte salts may be employed.

The concentration of the electrolyte salt is preferably set within the range of 0.5 mol/L or higher and 3 mol/L or lower, and more preferably set within the range of 1 mol/L or higher and 2 mol/L or lower. By prescribing such an electrolyte salt concentration, it is possible to realize an enhanced performance against the flow of high load currents, while the influence of a viscosity increase occurring due to an increased concentration of the electrolyte salt is suppressed.

The nonaqueous solvent is not particularly limited, and its examples may include cyclic carbonates such as propylene carbonate (PC) and ethylene carbonate (EC), chain carbonates such as diethyl carbonate (DEC), dimethyl carbonate (DMC), methyl ethyl carbonate (MEC), and dipropyl carbonate (DPC), 1,2-dimethoxyethane (DME), γ-butyrolactone (GBL), tetrahydrofuran (THF), 2-methyltetrahydrofuran (2-MeHF), 1,3-dioxolane, sulfolane, and acetonitrile (AN). One or a combination of two or more kinds of such solvents may be employed. It is preferable that the nonaqueous solvent contain a cyclic carbonate and/or a chain carbonate.

### (Separator)

A separator preferably has ion permeability and electrical insulating properties. As the separator, a porous film or nonwoven fabric made of polymer, such as polyolefin, cellulose, polyethylene terephthalate, or vinylon may be used. One or a combination of two or more kinds of materials may be used for the separator. Examples of the polyolefin include polyethylene, polypropylene, etc. Each separator may be constituted by a single layer. The separator may instead be of a multilayer constitution formed of a stack of two or more layers. The separator may have an inorganic particle layer or the like on its surface.

It is preferable that the separator is in physical contact with the positive electrode material layer via one of its surfaces and in physical contact with the negative electrode material layer via the other one of the surfaces. The thickness of the separator is preferably 4 μm or more and 10 μm or less from the viewpoint of insulating properties and a reduced resistance. A more preferable range is 4 μm or more and 8 μm or less. The thickness is even more preferred if it is 5 μm or more and 7 μm or less. It is preferable that the separator in the curved portion has a thickness of 10 μm or less. The thickness of the separator in the curved portion being 10 μm or less contributes to improved self-discharging performance or suppression of resistance increase. The lower limit of the thickness of the separator in the curved portion may be set to 4 μm. Note that the curved portion here refer to the first region 50 described with reference to FIG. 7.

A description will be given of a method for measuring the separator thickness. Ten separators are stacked, and the thickness of the separators is measured using a constant-pressure height measuring device manufactured by Mitutoyo Corporation. The measuring tool has a size of φ 5 mm. The thickness per separator is determined from the measurement value. The method for taking out the separator from the battery is as described for the measurement of air permeabilities.

It is preferable that the separator in the curved portion has a porosity of 50% or less. This can improve the self-discharging performance or suppress the resistance increase. The lower limit of the porosity of the separator in the curved portion may be set to 40%. Note that the curved portion here refer to the first region 50 described with reference to FIG. 7.

A description will be given of a method for measuring the separator porosity. The separator is taken out from the battery and washed with methyl ethyl carbonate (MEC). The washed separator is dried and then cut into a suitable size for use as a sample. Its true density is measured by a helium gas substitution method, and its outer dimension volume is measured by a mercury intrusion method. The porosity is calculated based on the true density (A) and the outer dimension volume (B) using the formula: Porosity (%)=1−(A/B)×100.

The battery according to the embodiment may further include any of a container member, a positive electrode lead, a negative electrode lead, a lid, a positive electrode terminal, a negative electrode terminal, a positive electrode backup lead, a negative electrode backup lead, a positive electrode insulating cover, a negative electrode insulating cover, a positive electrode gasket, a negative electrode gasket, a safety valve, and an electrolyte injection port. Note that the battery according to the embodiment may be, for example, a secondary battery capable of being charged and discharged.

Examples of the container member include a container made of a laminate film and a container made of metal.

As the laminate film, a multilayer film in which a metal layer is interposed between resin films may be used. The metal layer is preferably an aluminum foil or an aluminum alloy foil for a reduced weight. For the resin films, for example, a polymer material such as polypropylene (PP), polyethylene (PE), nylon, polyethylene terephthalate (PET), etc. may be employed. The laminate film may be formed into a shape of the container member by thermal fusion sealing. The laminate film preferably has a thickness of, for example, 0.2 mm or less.

The metal container may be made of aluminum, aluminum alloy, iron, stainless steel, etc. The lid may be made of aluminum, aluminum alloy, iron, stainless steel, etc. Preferably, the lid and the container member are formed of the same kind or kinds of metal. The metal container preferably has a thickness of, for example, 0.5 mm or less.

Portions of the positive electrode current collecting tab may be bundled by the positive electrode backup lead and electrically connected to the positive electrode terminal via the positive electrode lead. Also, portions of the negative electrode current collecting tab may be bundled by the negative electrode backup lead and electrically connected to the negative electrode terminal via the negative electrode lead.

The positive electrode lead is a conductive member for physically connecting the positive electrode terminal and the positive electrode backup lead to each other. The positive electrode lead may be a conductive member made of aluminum, an aluminum alloy, etc. The positive electrode lead and the positive electrode backup lead are preferably joined together by, for example, laser welding.

The negative electrode lead is a conductive member for physically connecting the negative electrode terminal and the negative electrode backup lead to each other. The negative electrode lead may be a conductive member made of aluminum, an aluminum alloy, etc. The negative electrode lead and the negative electrode backup lead are preferably joined together by, for example, laser welding.

The lid is a lid for the container member which accommodates the wound electrode group, and includes the positive electrode terminal and the negative electrode terminal. The lid may include the positive electrode terminal, the negative electrode terminal, the positive electrode insulating cover, the negative electrode insulating cover, the positive electrode gasket, the negative electrode gasket, the safety valve, and the electrolyte injection port. The lid is a molded member made of metal or an alloy such as aluminum, an aluminum alloy, iron, or stainless steel. The lid and the container member are preferably laser-welded or bonded via a sealing member such as an adhesive resin.

The positive electrode terminal is an electrode terminal for the positive electrode of the secondary battery and provided on the lid. The positive electrode terminal is formed of a conductive member such as aluminum, an aluminum alloy, etc. The positive electrode terminal is fixed to the lid via the positive electrode gasket having insulating properties. The positive electrode terminal is electrically connected to the positive electrode via the positive electrode lead and the positive electrode backup lead.

The negative electrode terminal is an electrode terminal for the negative electrode of the secondary battery and provided on the lid. The negative electrode terminal is formed of a conductive member such as aluminum, an aluminum alloy, etc. The negative electrode terminal is fixed to the lid via the negative electrode gasket having insulating properties. The negative electrode terminal is electrically connected to the negative electrode via the negative electrode lead and the negative electrode backup lead.

The positive electrode backup lead is a conductive member for bundling portions of the positive electrode current collecting tab and fixed to the positive electrode lead. The positive electrode backup lead and the positive electrode current collecting tab are preferably joined together by ultrasonic bonding.

The negative electrode backup lead is a conductive member for bundling portions of the negative electrode current collecting tab and fixed to the negative electrode lead. The negative electrode backup lead and the negative electrode current collecting tab are preferably joined together by ultrasonic bonding.

The positive electrode insulating cover is an insulating member for covering the positive electrode lead and the positive electrode backup lead. The positive electrode insulating cover fits to one end portion of the wound electrode group that includes the positive electrode current collecting tab. The positive electrode insulating cover is preferably a member having insulating and heat-resisting properties. As the positive electrode insulating cover, it is preferable to employ a molded resin object, a molded object of a material consisting mainly of paper, a member obtained by applying a resin coating on a molded object of a material consisting mainly of paper, or the like. A polyethylene resin or a fluorine resin is preferably used as the resin. The positive electrode insulating cover has such a shape that the positive electrode lead and the positive electrode backup lead are in contact with the container member via the positive electrode insulating cover. Use of the positive electrode insulating cover insulates the positive electrode and the container member from each other, and can protect the current collecting tab area (the current collecting tab, the lead, and the backup lead) from external impact.

The negative electrode insulating cover is an insulating member for covering the negative electrode lead and the negative electrode backup lead. The negative electrode insulating cover fits to one end portion of the wound electrode group that includes the negative electrode current collecting tab. The material, shape, etc. of the negative electrode insulating cover are the same as those of the positive electrode insulating cover. Descriptions common to the positive electrode insulating cover and the negative electrode insulating cover will be omitted.

The positive electrode gasket is a member for insulating the positive electrode terminal and the container member from each other. The positive electrode gasket is preferably a molded resin object having solvent-resistant and flame-retardant properties. For example, a polyethylene resin, a fluorine resin, or the like is used for the positive electrode gasket.

The negative electrode gasket is a member for insulating the negative electrode terminal and the container member from each other. The negative electrode gasket is preferably a molded resin object having solvent-resistant and flame-retardant properties. For example, a polyethylene resin, a fluorine resin, or the like is used for the negative electrode gasket.

The safety valve is a member provided for the lid and functioning as a pressure reducing valve for reducing the internal pressure of the container member in the event that the internal pressure has increased. It is preferable to provide the safety valve, but the safety valve may be omitted in view of conditions such as a protection mechanism adopted for the battery, materials of the electrodes, and so on.

The electrolyte injection port is a hole for injecting the electrolyte solution. In the state where the injection of the electrolyte solution has been done, the electrolyte injection port is preferably sealed with a resin or the like.

Preferably, the members are fixed or connected together using an insulating adhesive tape.

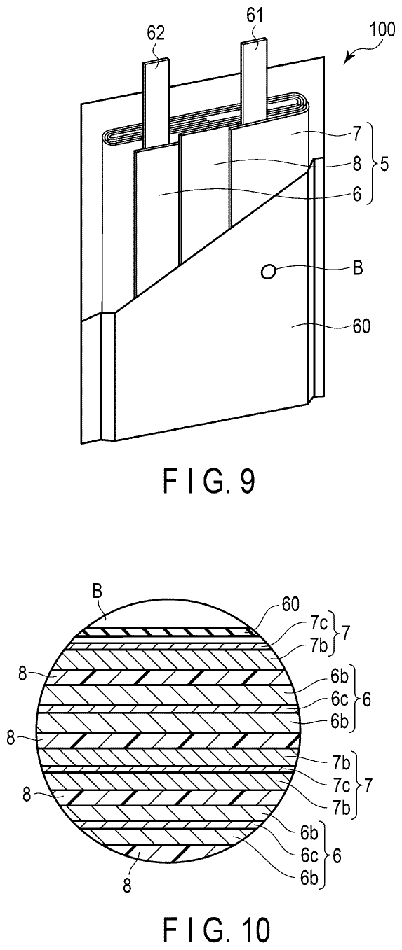

The battery according to the embodiment is not limited to the structure shown in FIG. 1 and such a possible example will be described with reference to FIGS. 9 and 10.

FIG. 9 is a partially cutaway perspective view of an exemplary nonaqueous electrolyte battery according to the embodiment. FIG. 10 is an enlarged cross-sectional view of a portion B of the nonaqueous electrolyte battery shown in FIG. 9.

The nonaqueous electrolyte battery 100 shown in FIGS. 9 and 10 includes a flat electrode group 5 and a container member 60 which is made of a laminate film. The flat electrode group 5 includes a negative electrode 7, a positive electrode 6, and separator 8. The flat electrode group 5 is formed by winding the negative electrode 7 and the positive electrode 6 in a flat shape with the respective separator 8 interposed therebetween.

The negative electrode 7 includes, as shown in FIG. 10, a negative electrode current collector 7c and negative electrode active material-containing layers 7b supported on the negative electrode current collector 7c. Note that, in the outermost portion of the negative electrode 7, the negative electrode active material-containing layer 7b is not supported on one major surface of the negative electrode current collector 7c which, among the two major surfaces of the negative electrode current collector 7c, does not face the positive electrode 6, as shown in FIG. 10. The other portions of the negative electrode 7 have the negative electrode active material-containing layers 7b supported on the respective major surfaces of the negative electrode current collector 7c. As shown in FIG. 10, the positive electrode 6 includes a positive electrode current collector 6c and positive electrode active material-containing layers 6b supported on two major surfaces of the positive electrode current collector 6c.

A strip-shaped negative electrode terminal 61 is electrically connected to the negative electrode 7. A strip-shaped positive electrode terminal 62 is electrically connected to the positive electrode 6.

The electrode group 5 is accommodated in the laminate film container member 60 with end portions of the negative electrode terminal 61 and the positive electrode terminal 62 extending out from the container member 60. A nonaqueous electrolyte (not shown in the figures) is accommodated in the laminate film container member 60. The electrode group 5 is impregnated with the nonaqueous electrolyte. The laminate film container member 60 is sealed by having its one end portion hold the negative electrode terminal 61 and the positive electrode terminal 62, and then thermally fusing, in this state, each of this one end portion and two end portions orthogonal to this one end portion.

According to the first embodiment described above, a battery includes an electrode group constituted by a flatly wound stack including a positive electrode, a negative electrode, and a separator. Here, Z/Y, where an air permeability of the separator located in the curved portion of the electrode group is Y (sec/100 mL) and an air permeability of the separator located in the flat portion of the electrode group is Z (sec/100 mL), is set to 1.03≤Z/Y≤1.11. This can suppress the self-discharge, short circuiting, and resistance increase of the battery.

### Second Embodiment

According to a second embodiment, a battery pack is provided. This battery pack includes the battery according to the embodiment.

The battery pack according to the embodiment may include one or more of such batteries. The batteries may be electrically connected in series or electrically connected in parallel. As another form, the batteries may be electrically connected by a combination of series and parallel arrangements. That is, the battery pack according to the embodiment may include a battery module. More than one such battery module may be included. The battery modules may be electrically connected in series, in parallel, or in combined series and parallel arrangements.

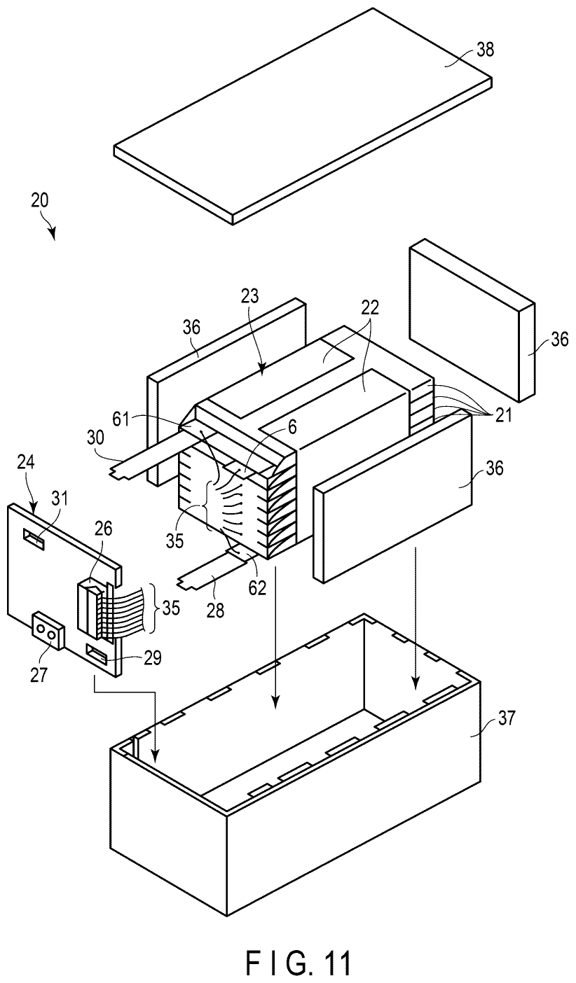

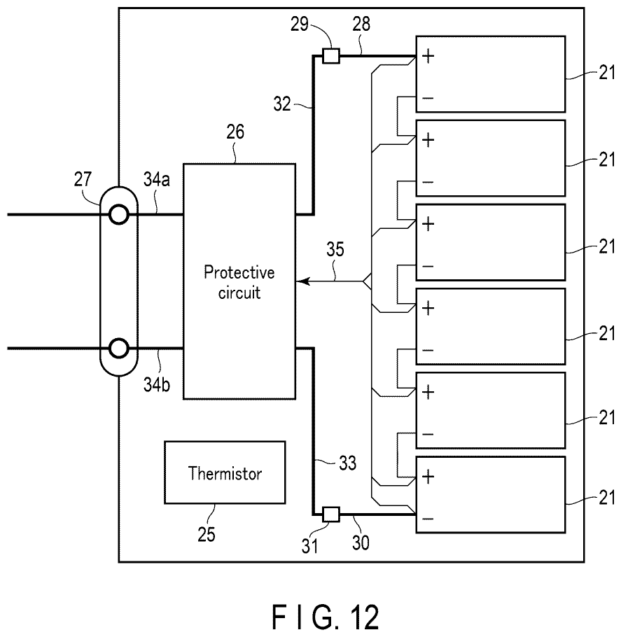

An exemplary battery pack according to the embodiment will be described with reference to FIGS. 11 and 12. FIG. 11 is an exploded perspective view showing an exemplary battery pack according to the embodiment. FIG. 12 is a block diagram showing exemplary electric circuitry of the battery pack shown in FIG. 11.

A battery pack 20 shown in FIGS. 11 and 12 includes two or more single batteries 21. Each single battery 21 may be, for example, an exemplary flat battery 100 according to the embodiment described with reference to FIG. 9.

The single batteries 21 are stacked such that their negative electrode terminals 61 and the positive electrode terminals 62 each extending out are aligned to face in the same direction, and the single batteries 21 are fastened with an adhesive tape 22 to constitute a battery module 23. These single batteries 21 are electrically connected in series as shown in FIG. 12.

A printed wiring board 24 is disposed to face the side surfaces of the single batteries 21 where the negative electrode terminals 61 and the positive electrode terminals 62 extend out. As shown in FIG. 12, the printed wiring board 24 is provided with a thermistor 25, a protective circuit 26, and a power distribution terminal 27 for supplying power to an external device. Also, an insulating plate (not shown in the figures) is attached to the surface of the printed wiring board 24 that faces the battery module 23, so as to avoid unnecessary connections with the wirings of the battery module 23.

A positive electrode-side lead 28 is connected to the positive electrode terminal 62 located at the lowermost layer of the battery module 23, and the tip of this positive electrode-side lead 28 is inserted into a positive electrode-side connector 29 of the printed wiring board 24 for electrical connection. A negative electrode-side lead 30 is connected to the negative electrode terminal 61 located at the uppermost layer of the battery module 23, and the tip of this negative electrode-side lead 30 is inserted into a negative electrode-side connector 31 of the printed wiring board 24 for electrical connection. These connectors 29 and 31 are connected to the protective circuit 26 via wirings 32 and 33 formed at the printed wiring board 24.

The thermistor 25 detects the temperature or temperatures of the single batteries 21 and the signals corresponding to the detection are sent to the protective circuit 26. The protective circuit 26 is adapted to interrupt, under predetermined conditions, a positive-side wiring 34a and a negative-side wiring 34b provided between the protective circuit 26 and the external device-intended power distribution terminal 27. One example of the predetermined conditions is the temperature detected by the thermistor 25 reaching or exceeding a predetermined temperature. Another example of the predetermined conditions is detection of overcharge, overdischarge, overcurrent, or the like in the single batteries 21. This detection of overcharge, etc. is performed for individual single batteries 21 or the battery module 23 as a whole. If each individual single battery 21 is the subject of detection, its battery voltage, or a potential at the positive electrode or the negative electrode may be detected. In the case of the latter, a lithium electrode serving as a reference electrode is inserted into each of the single batteries 21. In the battery pack 20 shown in FIGS. 11 and 12, a wiring 35 for voltage detection is connected to each of the single batteries 21. The detection signals are transmitted to the protective circuit 26 through these wirings 35.

Protective sheets 36 made of rubber or resin are arranged over respective three side surfaces of the battery module 23, except the side surface where the positive electrode terminals 62 and the negative electrode terminals 61 protrude.

The battery module 23, and also the protective sheets 36 and the printed wiring board 24, are accommodated in an accommodating container 37. More specifically, the protective sheets 36 are disposed respectively on both of the inner side surfaces of the accommodating container 37 that extend along the long side direction and one of the inner side surfaces of the accommodating container 37 that extend along the short side direction, and the printed wiring board 24 is disposed on the other inner side surface located oppositely via the battery module 23 and extending along the short side direction. The battery module 23 is located in the space surrounded by the protective sheets 36 and the printed wiring board 24. A lid 38 is attached to an upper surface of the accommodating container 37.

Note that the fixation of the battery module 23 may employ a heat-shrinkable tape instead of the adhesive tape 22. In this case, protective sheets are disposed on both side surfaces of the battery module and the heat-shrinkable tape is wound around them, and thereafter, the heat-shrinkable tape is heated so as to shrink and bind the battery module.

While FIGS. 11 and 12 illustrate a form where the single batteries 21 are connected in series, the single batteries 21 may be electrically connected in parallel for the sake of an increased battery capacity. Further, the assembled battery packs may also be electrically connected in series and/or in parallel.

Moreover, the form of the battery pack according to the embodiment may be discretionarily changed depending on its applications. Preferably, the application of the battery pack according to the embodiment is expected where a cycle performance corresponding to charge and discharge with large currents is desired. Specific applications may include a power source for digital cameras, in-vehicle usage for two- to four-wheel hybrid electric vehicles, two- to four-wheel electric vehicles, and assist bicycles, and so on. The battery pack according to the embodiment is particularly suitable for in-vehicle usage.

A battery pack according to the second embodiment includes the battery according to the embodiment. Therefore, the battery pack according to the embodiment can suppress the self-discharge, short-circuiting, and resistance increase.

### EXAMPLES

### Example 1

A spinel-type lithium manganese composite oxide LiMn₂O₄ and a layered-rock-salt-type lithium cobalt composite oxide LiCoO₂ as positive electrode active materials, PVdF as a binder, and graphite as a conductive agent were suspended in N-methylpyrrolidone so that a slurry for preparing a positive electrode was obtained. The mixture ratios of the LiMn₂O₄, LiCoO₂, PVdF, and graphite put in N-methylpyrrolidone were 80 wt %, 15 wt %, 2 wt %, and 3 wt %, respectively.

As a positive electrode current collector, an aluminum foil having a thickness of 15 μm was prepared. The positive electrode current collector had a shape of a strip extending in a first direction (long side direction) and having a width in a second direction (winding axis direction) orthogonal to the first direction. The slurry for a positive electrode prepared by the above-described step was applied to both of its surfaces and dried. In the course of applying the slurry for a positive electrode, a 10 mm of a strip-shaped slurry-uncoated portion extending in the first direction (long side direction) was left on a part of the front surface of the positive electrode current collector, so as to form a positive electrode current collecting tab. The resultant was dried and then cut so that the active material-containing layer (positive electrode material layer) on the positive electrode current collector had a width of 90 mm. After the cutting, the electrode was rolled under a constant load, and a positive electrode was thereby prepared.

### (Preparation of Negative Electrode)

A spinel-type lithium titanium composite oxide Li₄Ti₅O₁₂ as a negative electrode active material, PVdF as a binder, and graphite as a conductive agent were suspended in N-methylpyrrolidone so that a slurry for preparing a negative electrode was obtained. The mixture ratios of the lithium titanate, PVdF, and graphite put into N-methylpyrrolidone were 95 wt %, 2 wt %, and 3 wt %, respectively.

As a negative electrode current collector, an aluminum foil having a thickness of 15 μm was prepared. The negative electrode current collector had a shape of a strip extending in a first direction (long side direction) and having a width in a second direction (winding axis direction) orthogonal to the first direction. The slurry for a negative electrode prepared by the above-described step was applied to both of its surfaces and dried. In the course of applying the slurry for a negative electrode, a 10 mm of a strip-shaped slurry-uncoated portion extending in the first direction (long side direction) was left on a part of the front surface of the negative electrode current collector, so as to form a negative electrode current collecting tab. The resultant was dried and then cut so that the active material-containing layer on the negative electrode current collector had a width of 95 mm. After the cutting, the electrode was rolled under a constant load, and a negative electrode was thereby prepared.

### (Preparation of Wound Electrode Group)

As a separator, a polypropylene (PP) microporous film having a thickness of 5 μm was prepared. The positive electrode and the negative electrode thus obtained were, with the separator interposed therebetween, wound around an axis extending in the width direction of the positive electrode and the negative electrode. At this time, the positive electrode was wound 80 times and the negative electrode was wound 81 times while their positions were adjusted, so that the positive electrode material layer and the negative electrode material layer would not protrude from the separator and that the surface of the positive electrode material layer and the surface of the negative electrode material layer were kept facing each other, namely, so as not to make the surface of the positive electrode material layer larger than from the surface of the negative electrode material layer. An insulating tape having a thickness of 50 μm was put onto the surface of the outermost negative electrode material layer of the electrode group so as to fix the electrode group. The electrode group prepared by such a winding step was pressed under a load of 90 kN at a temperature of 25° C. for 60 seconds so that a flat wound electrode group was obtained. An air permeability Y of the separator located in the curved portion (R portion) of the flat wound electrode group and an air permeability Z of the separator located in the flat portion of the flat wound electrode group were measured by the method described above, and were found to be 67 sec/100 mL and 71 sec/100 mL, respectively. The ratio x of the air permeability Z to the air permeability Y is shown in Table 1.

Portions of the positive electrode current collecting tab were bundled together by being subjected to ultrasonic welding, and portions of the negative electrode current collecting tab were also bundled together by being subjected to ultrasonic welding. The obtained electrode group had an aspect ratio of 1.2.

### (Assembly of Battery)

The flat wound electrode group thus obtained and a nonaqueous electrolyte were placed in a bottomed rectangular container made of aluminum and having an opening. At this time, the placement was done so as to have the positive electrode current collecting tab and the negative electrode current collecting tab protrude from the end surface of the electrode group that was facing the opening. Next, a rectangular sealing plate made of aluminum was prepared. It had three openings. To one of these three openings, a positive electrode terminal of a rectangular column shape was fitted and fixed. A negative electrode terminal of a rectangular column shape was fitted and fixed via an insulating gasket to another one of the three openings. The remaining one of the three openings was an inlet port for injecting an electrolyte solution. Next, one end of the positive electrode terminal and the positive electrode current collecting tab of the electrode group were electrically connected to each other by laser welding. Likewise, one end of the negative electrode terminal and the negative electrode current collecting tab of the electrode group were electrically connected to each other by laser welding. Subsequently, the peripheral part of the sealing plate was welded to the container so as to close the opening of the container.

Next, a nonaqueous electrolyte solution was prepared. The preparation of the nonaqueous electrolyte solution was conducted by dissolving lithium hexafluorophosphate LiPF₆ at a concentration of 1.2 mol/L in a nonaqueous solvent prepared by mixing propylene carbonate (PC) and methyl ethyl carbonate (MEC) at a volume ratio of 1:1.

Next, the nonaqueous electrolyte solution produced as above was injected into the container through the electrolyte injection port provided in the sealing plate. Thereafter, a sealing lid was welded to the peripheral part of the electrolyte injection port, and the battery was therefore assembled.

### Example 2

A battery was assembled in the same manner as in Example 1 except that the electrode group was pressed under a load of 90 kN at a temperature of 25° C. for 45 seconds.

### Example 3

A battery was assembled in the same manner as in Example 1 except that the electrode group was pressed under a load of 90 kN at a temperature of 25° C. for 75 seconds.

### Example 4

A battery was assembled in the same manner as in Example 1 except that a polyethylene (PE) microporous film having a thickness of 5 μm was prepared as the separator and the produced electrode group was pressed under a load of 50 kN at a temperature of 25° C. for 20 seconds.

### Example 5

A battery was assembled in the same manner as in Example 1 except that a microporous polypropylene film having a thickness of 10 μm was prepared as the separator.

### Comparative Example 1

A battery was assembled in the same manner as in Example 1 except that the electrode group was pressed under a load of 90 kN at a temperature of 80° C. for 45 seconds.

### Comparative Example 2

A battery was assembled in the same manner as in Example 1 except that the electrode group was pressed under a load of 20 kN at a temperature of 25° C. for 10 seconds.

### (Measurement of Battery Capacity)

The batteries thus produced were charged at a constant current at 1 C under a 25° C. environment until 2.8 V, and thereafter charged at a constant voltage until the current value reached 0.1 C. After a 10 minutes rest under the 25° C. environment, the batteries were discharged at a constant current at 0.2 C until the voltage reached 1.8 V, and the capacity obtained by the discharge was adopted as the battery capacity.

(Measurement of Voltage after Charging)

After the battery capacity measurement, the batteries took a 10-minute rest under the 25° C. environment and were then charged at a constant current to a 70% capacity of the adopted battery capacity. The battery voltage was measured upon elapse of 24 hours and 72 hours from the charging, the results of which are denoted as V1 and V3, respectively. The difference between V1 and V3 (V1−V3) is shown in Table 1.

### (Measurement of Resistance)

After the V3 measurement, the batteries took a 10-minute rest under the 25° C. environment and were then discharged at a constant current at 0.2 C until the voltage reached 1.8 V. Subsequently, after a 10-minute rest, the batteries were charged at a constant current to a 50% capacity of the aforementioned adopted battery capacity. Then, after a 1-hour rest, the batteries were discharged for 10 seconds at 10 C. Here, the resistance was calculated from the difference between the pre-discharge voltage and the post-discharge voltage and the current values, and was taken as a “10-second discharge resistance”. The values are shown in Table 1.

Table 1 also shows, for each of the batteries according to the examples and the comparative examples, the air permeability Z of the separator in the flat portion, the air permeability Y of the separator in the curved portion (R portion), the ratio x (Z/Y) of the air permeabilities, the porosity of the separator in the curved portion, the thickness of the separator in the curved portion, and the material of the separator. The air permeability, the porosity, and the thickness were measured by the methods as described above.

TABLE 1

| | | Air | Air permeability Z | | | | Voltage after | |
|---|---|---|---|---|---|---|---|---|
| | Air | permeability | of separator in flat | | | | 1 day from | |
| | permeability | Y of | portion/air | Porosity of | Thickness of | | charging- | |
| | Z of | separator in | permeability Y of | separator | separator | | voltage after | 10-second |
| | separator in | curved | separator in | in curved | in curved | | 3 days from | discharge |
| | flat portion | portion | curved portion | portion | portion | Material of | charging | resistance |
| | [sec/100 mL] | [sec/100 mL] | (ratio X) | [%] | [μm] | separator | (V1-V3) [mV] | [mΩ] |
| Ex. 1 | 71 | 67 | 1.06 | 42 | 4 | PP | 1.3 | 0.30 |
| Ex. 2 | 71 | 69 | 1.03 | 42 | 4 | PP | 1.6 | 0.28 |
| Ex. 3 | 71 | 64 | 1.110 | 42 | 4 | PP | 1.1 | 0.33 |
| Ex. 4 | 87 | 83 | 1.05 | 47 | 4 | PE | 1.3 | 0.28 |
| Ex. 5 | 71 | 67 | 1.06 | 42 | 10 | PP | 1.0 | 0.35 |
| Comp. | 105 | 67 | 1.57 | 42 | 4 | PP | 0.8 | 0.70 |
| Ex. 1 | | | | | | | | |
| Comp. | 68 | 67 | 1.01 | 42 | 4 | PP | 5.5 | 0.20 |
| Ex. 2 | | | | | | | | |

As clearly seen from Table 1, Examples 1 to 5 showed a small voltage drop after the charging, and also showed a lower self-discharge. Also, Examples 1 to 5 incurred a low resistance along the discharge at 10C, which represents a high rate discharge; as such, excellent results were obtained. This is considered to be attributable to the electrolyte solution first penetrating into the separator located in the R portions of the electrode group and then penetrating into the flat portions located in the direction perpendicular to the winding axis, so that the electrodes in the flat portions, to their very inside, were impregnated with the electrolyte solution.

In Comparative Example 1, although a small self-discharge was observed, the resistance increased as compared to the Examples. The reason would be that, since the air permeability of the separator located in the flat portions of the electrode group was larger than the air permeability of the separator located in the R portions of the electrode group, the electrolyte solution first penetrated into the separator in the R portions but was then prevented from penetrating into the flat portions located in the direction perpendicular to the winding axis, which resulted in failure of electrolyte solution impregnation of the inside of the electrodes in the flat portions and consequently increased the resistance.

In Comparative Example 2, although a low resistance along the high-rate discharge was observed, the self-discharge increased as compared to the Examples. The reason would be that, since the air permeability of the separator located in the flat portions of the electrode group was lower, the self-discharge between the positive electrode and the negative electrode in the flat portions increased.

According to at least one of the foregoing embodiments and the Examples, a battery includes an electrode group constituted by a flatly wound stack including a positive electrode, a negative electrode, and a separator. Here, Z/Y, where an air permeability of the separator located in the curved portion of the electrode group is Y (sec/100 mL) and an air permeability of the separator located in the flat portion of the electrode group is Z (sec/100 mL), is 1.03≤Z/Y≤1.11. This can suppress the self-discharge, short circuiting, and resistance increase of the battery.

In the following, the disclosure according to the embodiments is additionally written.
<1>. A nonaqueous electrolyte battery including an electrode group and a nonaqueous electrolyte, the electrode group including a flatly wound stack including a positive electrode, a negative electrode, and a separator arranged between the positive electrode and the negative electrode, wherein
Z/Y, where an air permeability of the separator located in a curved portion of the electrode group is Y (sec/100 mL) and an air permeability of the separator located in a flat portion of the electrode group is Z (sec/100 mL), is 1.03<Z/Y≤1.11.
<2>. The nonaqueous electrolyte battery according to <1>, wherein the separator is a porous film containing polyolefin.
<3>. The nonaqueous electrolyte battery according to <1> or <2>, wherein the separator located in the curved portion has a thickness of 10 μm or less.
<4>. The nonaqueous electrolyte battery according to any one of <1> to <3>, wherein the separator located in the curved portion has a porosity of 50% or less.
<5>. The nonaqueous electrolyte battery according to any one of <1> to <4>, wherein the Z/Y is 1.03≤Z/Y≤1.110.
<6>. The nonaqueous electrolyte battery according to any one of <1> to <5>, wherein each of the air permeability Y of the separator and the air permeability Z of the separator is 10 sec/100 mL or more and 100 sec/100 mL or less.
<7>. The nonaqueous electrolyte battery according to any one of <1> to <6>, wherein the negative electrode contains at least one selected from the group consisting of spinel-type lithium titanate, ramsdellite-type lithium titanate, and a niobium titanium composite oxide.
<8>. The nonaqueous electrolyte battery according to any one of <1> to <7>, wherein the electrode group has an aspect ratio of 1.1 or more and 1.7 or less.
9. A battery pack including the nonaqueous electrolyte battery according to any one of <1> to <8>.

While certain embodiments have been described, these embodiments have been presented by way of example only, and are not intended to limit the scope of the inventions. Indeed, the novel embodiments described herein may be embodied in a variety of other forms. Furthermore, various omissions, substitutions, and changes in the form of the embodiments may be made without departing from the spirit of the inventions. The accompanying claims and their equivalents are intended to cover such forms or modifications as would fall within the scope and spirit of the inventions.

What is claimed is:

1. A nonaqueous electrolyte battery comprising an electrode group and a nonaqueous electrolyte, the electrode group comprising a flatly wound stack comprising a positive electrode, a negative electrode, and a separator arranged between the positive electrode and the negative electrode, wherein
Z/Y, where an air permeability of the separator located in a curved portion of the electrode group is Y (sec/100 mL) and an air permeability of the separator located in a flat portion of the electrode group is Z (sec/100 mL), is 1.03≤Z/Y≤1.11.

2. The nonaqueous electrolyte battery according to claim 1, wherein the separator is a porous film containing polyolefin.

3. The nonaqueous electrolyte battery according to claim 1, wherein the separator located in the curved portion has a thickness of 10 μm or less.

4. The nonaqueous electrolyte battery according to claim 3, wherein the separator located in the curved portion has a porosity of 50% or less.

5. The nonaqueous electrolyte battery according to claim 1, wherein the Z/Y is 1.03≤Z/Y≤1.110.

6. The nonaqueous electrolyte battery according to claim 1, wherein each of the air permeability Y of the separator and the air permeability Z of the separator is 10 sec/100 mL or more and 100 sec/100 mL or less.

7. The nonaqueous electrolyte battery according to claim 1, wherein the negative electrode comprises at least one selected from the group consisting of spinel-type lithium titanate, ramsdellite-type lithium titanate, and a niobium titanium composite oxide.

8. The nonaqueous electrolyte battery according to claim 1, wherein the electrode group has an aspect ratio of 1.1 or more and 1.7 or less.

9. A battery pack comprising the nonaqueous electrolyte battery according to claim 1.
